(19) United States
(12) Patent Application Publication
(10) Pub. No.: US 2016/0281678 A1
(43) Pub. Date: Sep. 29, 2016

(54) ENERGY RECOVERY SYSTEMS FOR VENTILATION EXHAUSTS AND ASSOCIATED APPARATUSES AND METHODS

(71) Applicants: University of Washington through its Center for Commercialization, Seattle, WA (US); Second Wind, Inc., Redmond, WA (US)

(72) Inventors: Mark D. DAVIS, Seattle, WA (US); Alberto ALISEDA, Seattle, WA (US); Michael C. KUDRIAVTSEFF, Seattle, WA (US); Jeremy YANDELL, Woodbridge, VA (US); William J. SETTER, Mercer Island, WA (US); Chad R. N. GRENNER, Woodinville, WA (US)

(21) Appl. No.: 15/034,861

(22) PCT Filed: Nov. 15, 2013
(86) PCT No.: PCT/US2013/070433

§ 371 Date: May 5, 2016

(51) Int. Cl. F03D 1/04; H02K 7/18; F03D 9/00; F24F 7/00; F24F 7/06

(52) U.S. Cl. CPC F03D 1/04; F24F 7/00; F24F 7/06; F03D 9/002; H02K 7/1823; F05B 2220/604; F05B 2220/64; F24F 2007/001

(57) ABSTRACT

Apparatuses and associated methods for producing energy from building or mine ventilation exhausts are disclosed herein. In one embodiment, an apparatus for extracting energy from the ventilation exhaust includes a turbine rotor having a plurality of turbine blades that are at least partially airfoils (e.g., NACA or SG60XX airfoils). A flow conditioner may be positioned to direct the exhaust air to the turbine. In some embodiments, the turbine rotor may be configured to rotate at high RPM. Accordingly, a rotating shaft of the turbine can be connected with an electrical generator without an intervening gearbox. In some embodiments, electricity produced by the electrical generator can be fed directly to the electrical wiring of the building or mine to offset energy consumption of the ventilation system.

### TECHNICAL FIELD

The present technology is generally related to energy recovery systems for ventilation exhausts and associated apparatuses and methods. In particular, several embodiments of the present technology are directed to producing electrical energy using a turbine positioned at an exhaust vent.

### BACKGROUND

Air turbines may be configured to convert kinetic energy from air into mechanical torque. In particular, as air flows past blades of the turbine, a lift force is created on the blades. The lift force creates torque that can rotate a shaft to which the blades are attached. When an electrical generator is coupled to the drive shaft via, for example, a gearbox, rotation of the shaft generates electrical energy. Therefore, a combination of an air turbine and a generator can extract energy from air flow from the wind) to produce electrical energy. A known advantage of such energy extraction is its low environmental impact because wind turbines can generate electricity in a sustainable way and with minimal environmental pollution. Since wind speeds vary widely in nature, an economical wind turbine should be reasonably efficient at a range of wind speeds. Therefore, many utility scale wind turbines use turbine blades with variable blade pitch to maximize energy extraction from the wind by adjusting the blade pitch based on the velocity of the wind. However, mechanisms that vary blade pitch can be expensive and prone to failure.

Air turbines can also be used to extract energy from the waste air exhausts of computers, servers, mines, and/or buildings. Many such conventional systems that produce electrical energy from exhaust air, however, are inefficient at extracting energy from moving air. FIG. 1, for example, is a partially schematic isometric view of a conventional energy recovery system 10 configured to generate electrical energy based on exhaust air from a computer or server 19. In operation, a stream of cooling air is exhausted through an opening 18 on the computer. A stand 12 is attached to the computer 19 to hold a turbine 14 in an airflow path of the cooling air. A shaft 15 is configured to transfer rotation of the turbine 14 to a generator 16. Here, some portion of the cooling air coming from the opening 18 can escape turbine 14 because, for example, the generator 16 creates a backpressure in the path of the cooling air. This escape of the cooling air reduces the efficiency of the illustrated conventional system.

FIG. 2 is a partially schematic isometric view of another conventional system 20 for producing electrical energy from the cooling air of a computer. In this arrangement, a shroud 27 is attached directly over a cooling air exhaust (not visible) of a computer 29. Tabs 23 are used to attach the shroud 27 to the computer 29. A turbine (not visible) is positioned inside the shroud 27 and is attached to a generator 21. As the cooling air leaves the computer 29, it enters the shroud, rotates the turbine that is connected with the generator 21 through a shaft, and exhausts through space between the turbine 21 and shroud 27. The system 20 is configured to minimize air flow loss, but the generator and the turbine inside the shroud 27 can generate significant back pressure, which reduces the flow of cooling air.

FIG. 3 is a partially schematic cross-sectional view of a conventional system 30 for producing electrical energy from the waste air of a building or mine. During operation, a stream 31 of waste air is typically produced by ventilation or air-conditioning systems. The stream 31 enters a shroud 37 and is directed toward a pair of turbines 34 mounted on a shaft 35. The waste air is exhausted from the system 30 through an exit shroud 33a. The amount of exhaust air that passes through the turbines 34 can be adjusted through a lateral offset between shrouds 33a and 33b. For example, increasing the lateral offset between the shrouds 33a and 33h allows more air to escape before reaching the turbines 34. Rotational energy from the shaft 35 is transferred through a pair of pulleys 32a and 32b and a belt 38 to a generator 36. In the system 30, the generator 36 is not in the airflow path of the stream 31 and, therefore, back pressure is typically not increased by the generator 36. However, the relatively high solidity of the turbines 34 (i.e., relatively large and numerous turbine blades in the airflow path) increases back pressure in the shroud 37 and further upstream. Another drawback with the system 30 is that the pulley/belt transmission typically has a smaller torque transfer capability and higher mechanical losses than a direct shaft mount of a generator to turbine shaft arrangement. Furthermore, the conventional system 30 includes a relatively large number of conventional turbine blades. Such blades are relatively inefficient at transferring air flow into torque and, accordingly, negatively affect the overall efficiency of the system 30.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. Furthermore, components can be shown as transparent in certain views for clarity of illustration only and not to indicate that the illustrated component is necessarily transparent.

FIG. 1 is a partially schematic isometric view of an energy recovery system configured in accordance with conventional technology.

FIG. 2 is a partially schematic isometric view of another energy recovery system configured in accordance with conventional technology.

FIG. 3 is a partially schematic cross-sectional view of an energy recovery system configured in accordance with conventional technology.

FIG. 4 is a partially schematic side view of an energy recovery system configured in accordance with the present technology.

FIG. 5 is an isometric view of the turbine assembly of FIG. 4.

FIG. 6A is an isometric view of the turbine rotor of FIG. 4.

FIG. 6B is a cross-sectional view of a turbine blade configured in accordance with the present technology.

FIG. 7 is a partial cross-sectional view of the turbine blade and shaft configured in accordance with an embodiment of the present technology.

FIG. 8 is a cross-sectional view of the flow conditioner in accordance with an embodiment of the present technology.

FIG. 9 is a graph illustrating coefficient of power and coefficient of torque as a function of tip speed ratio for a turbine configured in accordance with the present technology.

FIG. 10 is a graph illustrating theoretical and measured power as a function of angular velocity for a turbine configured in accordance with the present technology.

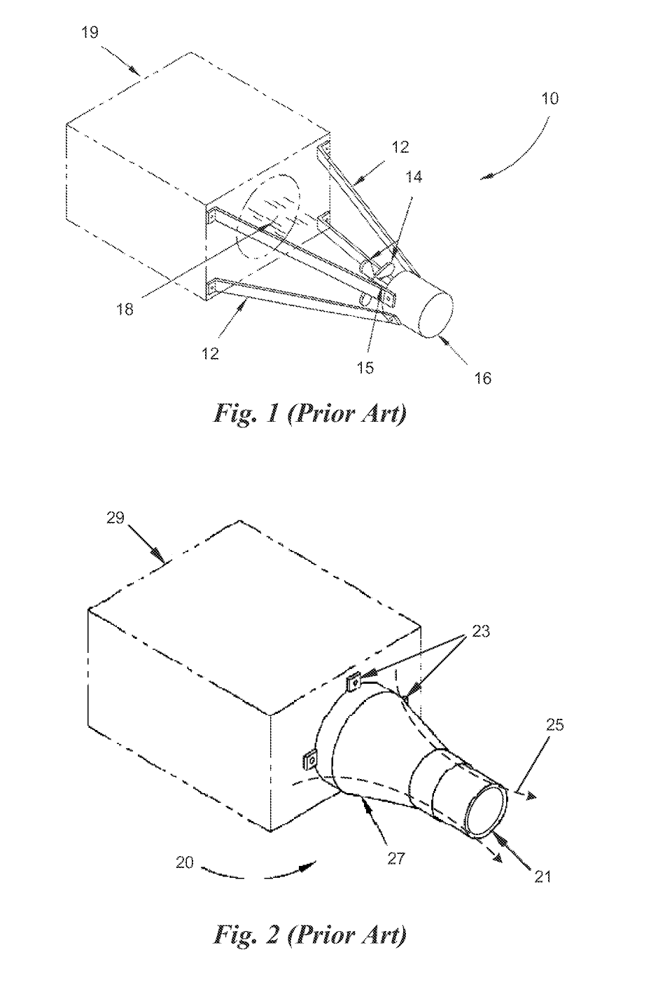

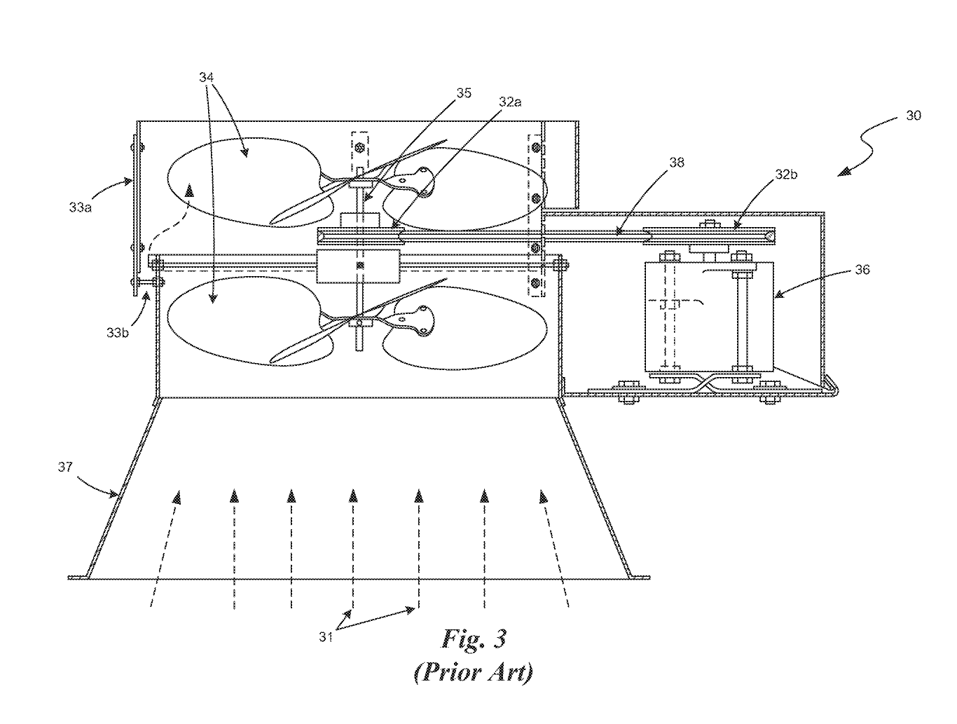

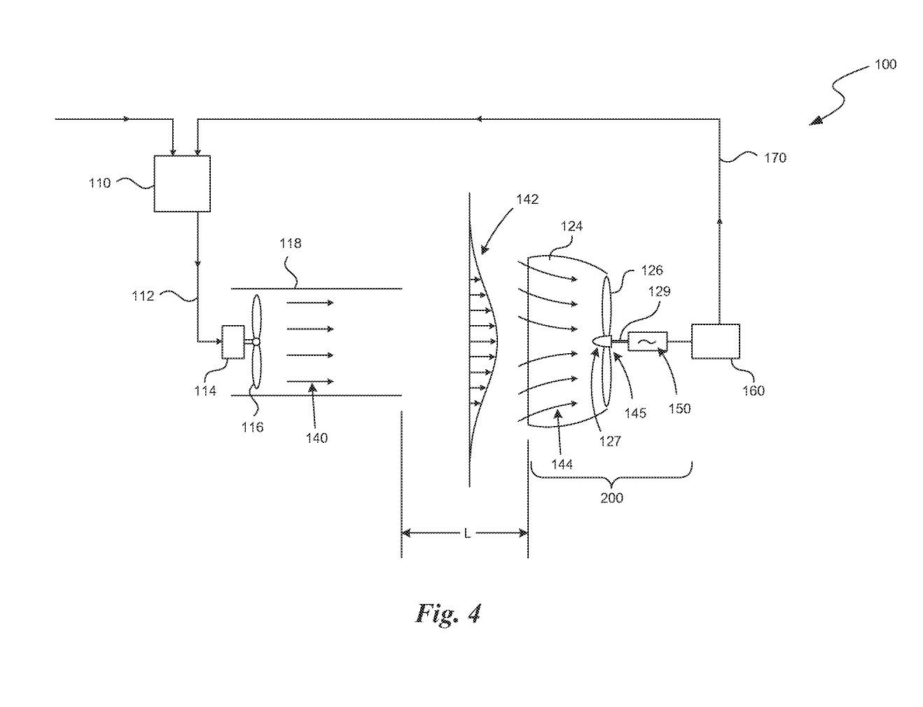

### DETAILED DESCRIPTION

The present technology relates generally to energy recovery systems for high flow exhausts and associated apparatuses and methods. The exhausted air, for example, may be coming out of an air conditioning or ventilation system of a building or a mine In particular, some embodiments of the present technology are directed to a system having turbine blades that are optimized for an exhaust air stream of a generally constant velocity. For example, in at least some embodiments, a turbine blade specifically designed to operate at a fixed air velocity may have greater efficiency than a turbine blade optimized to operate over a range of velocities. Furthermore, in some embodiments of the present technology, a pitch angle of the turbine blades may be fixed. This arrangement is expected to eliminate the need for an additional mechanism to vary the pitch angle of the turbine blades. In some embodiments, the turbine can have two blades that are based on either NACA or SG60XX airfoils (where “SG60” identifies a family of airfoils and “XX” refers to a particular member of the family).

Turbines configured in accordance with the present technology can operate at a tip speed ratio (i.e., ratio of the velocity of the tip of the blade vs. speed of wind) in excess of 10, whereas most conventional wind turbines operate at tip speed ratios of 5-7. In some embodiments of the present technology, the turbine is expected to achieve about 30%-50% efficiency in converting the kinetic energy of the exhaust air to turbine work. Furthermore, the relatively thick turbine blades of the present technology are expected to be less sensitive to accumulation of dust and other particles that are normally present in the exhaust air. Moreover, due to the thickness of the blades, the blades can be made using inexpensive technologies and materials (e.g., compression molding).

In some embodiments of the present technology, a flow conditioner can be used to (a) direct the flow of exhaust air toward the turbine and (b) reduce air escape around the turbine. The flow conditioner and the turbine, for example, can be positioned away from the air stream source while still directing most air coming from the exhaust toward the turbine. In some embodiments of the present technology, the turbine can operate at a relatively high angular velocity (revolutions per minute or RPM) that matches the input RPM of a generator (e.g., 1,500-3,500 RPM). This is expected to eliminate the need for a gearbox connecting the shafts of the turbine and the generator. In some embodiments, the generator may be configured to output electricity at a voltage/frequency suitable for a direct feed (direct connection) to a building's or mine's electrical system, thereby reducing the need for external energy supplied.

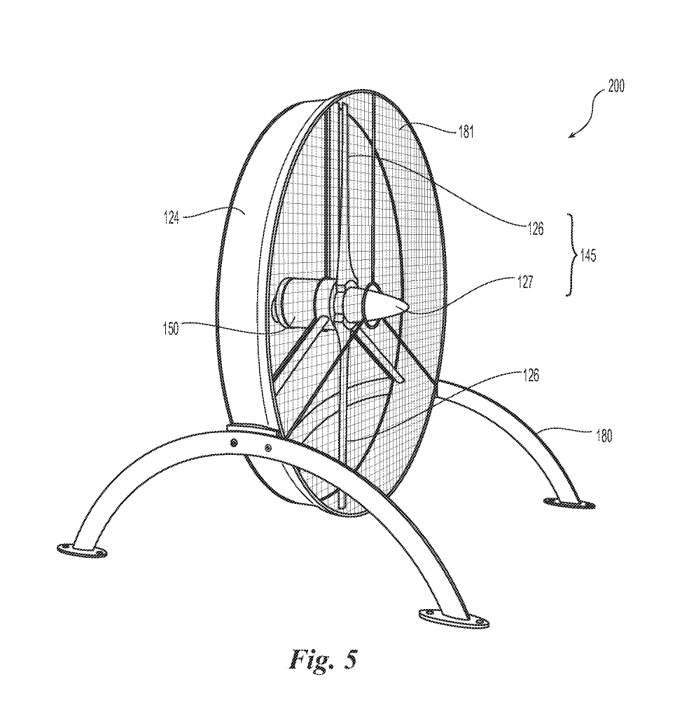

Specific details of several embodiments of the present technology are described herein with reference to FIGS. 4-10. Although many of the embodiments are described below with respect to producing energy from building or mine exhaust air, other applications are within the scope of the present technology. Additionally, other embodiments of the present technology can have different configurations, components, or procedures than those described herein. For example, other embodiments can include additional elements and features beyond those described herein, or other embodiments may not include several of the elements and features shown and described herein.

### A. SELECTED EMBODIMENTS OF ENERGY RECOVERY SYSTEMS

FIG. 4 is a partially schematic side view of an energy recovery system 100 (“system 100”) configured in accordance with an embodiment of the present technology. The system 100 is configured for extracting energy from an exhaust flow 140 coming out of an exhaust duct 118 of a building or a mine. The system 100 can include, for example, a turbine assembly 200 including a turbine rotor 145 having a plurality of turbine blades 126. As described in greater detail below, the turbine blades 126 comprise airfoils. The system 100 can also include a flow conditioner 124 positioned to direct the exhaust flow 140 to the turbine rotor 145 and a rotating shaft 129 connecting the turbine rotor 145 with an electrical generator 150.

The exhaust flow 140 can be provided by an air conditioning or a ventilation system, but it can also come from different sources. The exhaust flow 140 coming out of the exhaust duct H 8can be horizontal, vertical, or at another angle relative to the ground (not shown). The exhaust flow 140 can be provided by a fan 116 that is powered by a fan motor 114. The exhaust flow 140 is, for the most part, characterized by constant or near constant velocity. Although only a single fan 116 is shown for clarity, it will be appreciated that the system 100 may include a number of additional fans 116 as well as other ventilation or air conditioning components as part of the ventilation or air conditioning system. The fan motor 114 may be configured to receive power through an electrical feed 112 that is connected to a wiring cabinet 110 configured to provide power to the fan motor 114.

During operation, upon leaving the exhaust duct 118, the exhaust flow 140 develops into a jet 142 that flows toward the flow conditioner 124. In some embodiments of the present technology, the flow conditioner 124 can be offset from an outlet of the exhaust duct 118 by a distance L. In some embodiments, the distance L may correspond to 25% to 200% of an inlet diameter of the flow conditioner. The flow conditioner 124 is positioned to direct and concentrate flow of the exhaust flow 140 toward the downstream turbine rotor 145.

As noted previously, the turbine rotor 145 can have two or more turbine blades 126. In at least some embodiments, the turbine blades 126 can be based on NACA airfoils or SG60XX airfoils (e.g., an NACA4415 airfoil, an SG6043 airfoil). In other embodiments, however, the turbine blades 126 may have other configurations and/or the turbine rotor 145 may include a different number of turbine blades 126.

In at least some embodiments of the present technology, rotation of the turbine shaft 129 can be matched to a particular generator such that the rotation (RPM) of the turbine shaft 129 causes the generator 150 to produce a voltage of required frequency and phase without a need for an additional gearbox or similar device to change the speed of rotation (RPM) of the turbine shaft 129. Further, the electrical energy produced by the generator 150 may be further conditioned in a voltage regulator 160. In some embodiments, for example, the voltage regulator 160 can be a transformer capable of producing a voltage/phase corresponding to an input voltage and phase of the wiring cabinet 110, for example, a 3-phase, 480V voltage. In other embodiments, the voltage regulator 160 can produce a voltage/phase suitable for other purposes (e.g., other line voltages). In arrangements where the electricity coming out of the voltage regulator 160 is electrically coupled with the wiring cabinet 110 through a line 170, at least a portion of the energy consumption of the building or mine air conditioning and/or ventilation system can be provided by the system 100. This arrangement is expected to reduce the overall energy consumption of the air conditioning and/or ventilation.

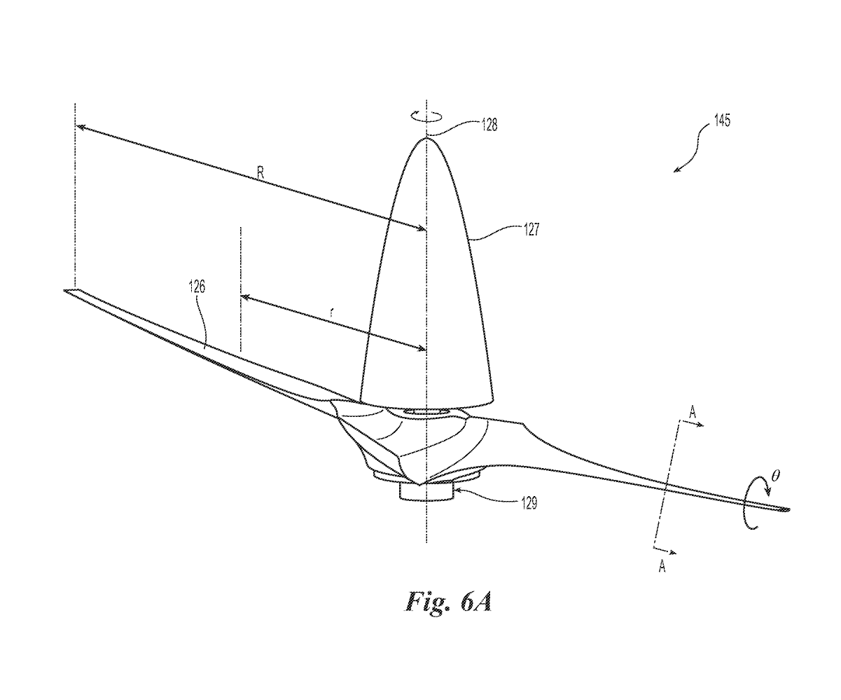

FIG. 5 is an isometric view of the turbine assembly 200 of FIG. 4. As best seen in FIG. 5, the turbine assembly is configured for receiving an exhaust flow of air (e.g., exhaust flow 140 of FIG. 4) in a horizontal or generally horizontal direction. The exhaust flow can be directed toward the turbine rotor 145 by the flow conditioner 124. The turbine rotor 145 can include the turbine blades 126 and a turbine hub 127 that can be at least partially protected by mesh 181. As noted previously, turbine rotor 145 includes two turbine blades 126, but in other embodiments the turbine rotor 145 may include a different number of turbine blades 126. As also noted above, in at least some embodiments of the present technology, rotation of the turbine rotor 145 can be directly transferred to the generator 150 without any additional equipment, e.g., a gearbox connecting the shafts of the turbine and generator. The turbine assembly 200 can include turbine mounts 180 configured to secure the assembly 200 to a horizontal surface (e.g., a fiat roof of a building). In other embodiments, the turbine assembly 200 may include different features and/or have a different arrangement. In some embodiments, for example, the turbine assembly 200 may be configured for vertical and/or inclined exhaust air flow.

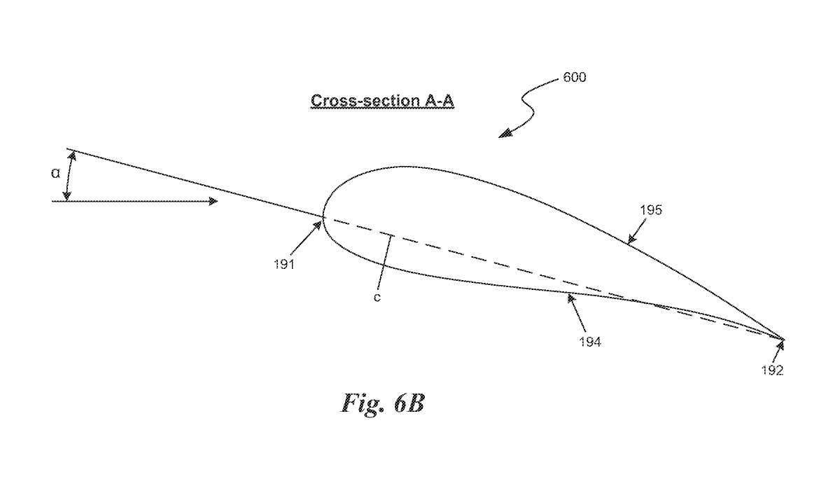

FIG. 6A is an isometric view of the turbine rotor 145 of FIGS. 4 and 5. In at least some embodiments of the present technology, the turbine blades 126 can be manufactured from a single piece of material using, f©r example, compression molding. A relatively thick turbine blade 126 is expected to have a low sensitivity to dust and other particles within the exhaust flow. A relatively small number of turbine blades (e.g., two blades) having relatively small width results in a low solidity of the turbine rotor 145. When everything else is kept the same, low solidity of a turbine improves its efficiency. Angle θ indicates a twist angle of the turbine blade 126 (and is discussed in more detail below with reference to Table 1). As best seen in FIG. 6A, each turbine blade 126 has a full span R. The element “r” denotes a location on the turbine blade 126 between a centerline 128 and the full span R. Generally, in operation, exhaust flow approaches the turbine rotor 145 along a flow path generally parallel to the centerline 128 and proceeds past the turbine hub 127 and toward the turbine blades 126, which then rotate about the centerline 128. In some embodiments, the turbine blades 126 can be forward swept into the incoming flow such that the turbine blades straighten under the pressure of the flow, resulting in generally straight turbine blades when in operation. A representative cross-section of the turbine blade 126 is shown in FIG. 6B.

FIG. 6B is a cross-sectional view of the turbine blade 126 taken along line A-A of FIG. 6A. Referring to FIGS. 6A and 63 together, angle α indicates an angle or tack of the airfoil 600 as it rotates about the centerline 128 (FIG. 6A). The airfoil 600 comprises a leading edge 191 and a trailing edge 192. The airfoil 600 also includes a lower surface 194 and an upper surface 195. A chord line “c” is a straight line connecting the leading edge 191 with the trailing edge 192.

As mentioned above, in some embodiments of the present technology the airfoil 600 can be based at least in part on the NACA and/or SG60XX family of airfoils, for example NACA4415 or SG6043. In other embodiments, however, other suitable airfoils can also be used. The use of these and other airfoils is expected to result in greater efficiency in conversion of the kinetic energy of the incoming exhaust flow into the torque of the turbine shaft.

In some instances, the twist angle θ and the chord c of the turbine blade 126 can change along the span R of the turbine blade 126 to optimize performance of the turbine rotor 145. Some values of the twist angle θ and chord c as a function of location along the span R of the turbine blade 126 are shown below in Table 1.

TABLE 1

| r/R | Θ | c/R |
|---|---|---|
| 0%-25% | 10°-30° | 8.5%-25% |
| 25%-50% | 1°-10° | 4.5%-8.5% |
| 50%-70% | (−1.5°)-1° | 3%-4.5% |
| 70%-100% | (−1.5)°-(−1)° | 0%-3% |

By way of example, for a location along the length of the turbine blade 126 that corresponds to 0 to 25% of the overall length of the turbine blade (i.e., r/R=0%-25%) the twist angle θ can be 10° to 30°, whereas the ratio of chord over length of the turbine blade (i.e., c/R) can be 8.5% to 25%. Further away from the centerline 128 of the turbine rotor 145, for example at 25% to 50% of the length of the turbine blade 126, the twist angle θ can be 1° to 10°, whereas the ratio of the chord versus the length of the turbine blade 126 can be 4.5% to 8.5%. Still further away from the centerline 128 at 50% to 70% of the length of the turbine blade 126, the twist angle θ can be (−1.5° to 1°, whereas the ratio of chord over the length of the turbine blade 126 can be 3% to 4.5%. Lastly, at 70% to 100% of the span of the turbine blade 126, the twist angle θ can be in the negative range, for example −(1)° to −(1.5)°, and the ratio of the chord versus full length of the turbine blade 126 can be 0% to 3%. The values of the θ and c/R. in Table 1 can be calculated as functions of r/R, as shown in the inequalities 1 and 2 below.

$$\begin{matrix}10 - 71.18 \frac{r}{R} + 185.1 {( \frac{r}{R} )}^{2} - 177.4 {( \frac{r}{R} )}^{3} < θ < 60.24 - 142.1 \frac{r}{R} + 86.37 {( \frac{r}{R} )}^{2} - 5.925 {( \frac{r}{R} )}^{3} & ( 1 ) \\ 8.5 - 28.14 \frac{r}{R} + 62.85 {( \frac{r}{R} )}^{2} - 57.14 {( \frac{r}{R} )}^{3} < c / R < 62.70 - 205.2 \frac{r}{R} + 241.8 {( \frac{r}{R} )}^{2} - 96.29 {( \frac{r}{R} )}^{3} & ( 2 )\end{matrix}$$

The above combination of θ and c/R along the length of the turbine blade is expected to result in improved efficiency of the turbine for an exhaust flow of generally constant velocity. For example, in some embodiments of the present technology, the above combination of the twist angle and the ratio of chord versus length of the turbine blade is expected to result in overall efficiency of the turbine ranging from about 30% to about 50%. In contrast, conventional wind turbines generally have overall efficiency of approximately 30% or less. It will be appreciated that the turbine blades 126 may have different arrangements and/or dimensions in other embodiments.

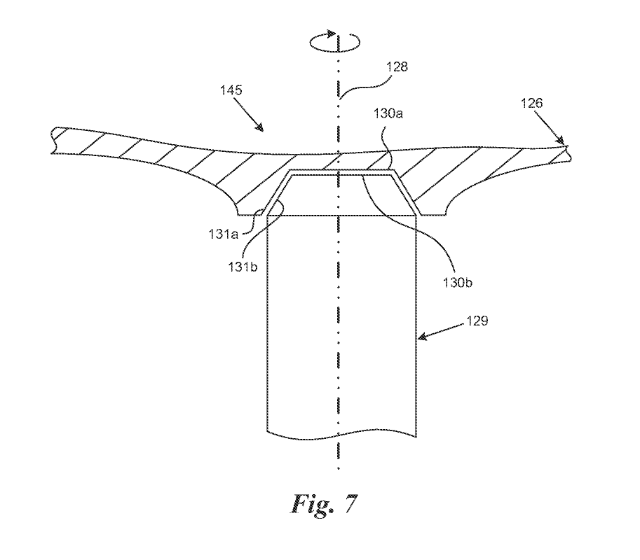

FIG. 7 is a partial cross-sectional view of an arrangement of the turbine rotor 145 configured in accordance with an embodiment of the present technology. In the illustrated embodiment, the turbine shaft 129 and the turbine rotor 145 are centered about the centerline 128. The turbine rotor 145 can include a turbine inset 130a configured to receive an end of the turbine shaft 129. The turbine inset 130a can include a generally conical turbine inset side 131a. The turbine shaft 129 can also include a corresponding generally conical shaft side 131b complementary to the turbine inset side 131a. The arrangement of the turbine inset 130a and the shape of the end of the turbine shaft 129 is designed to help center the turbine rotor 145 with respect to the turbine shaft 129. In other embodiments, the turbine inset side 131a and the shaft side 131b may have a variety of other suitable complementary shapes (e.g., cylindrical, hemispherical, or other shapes).

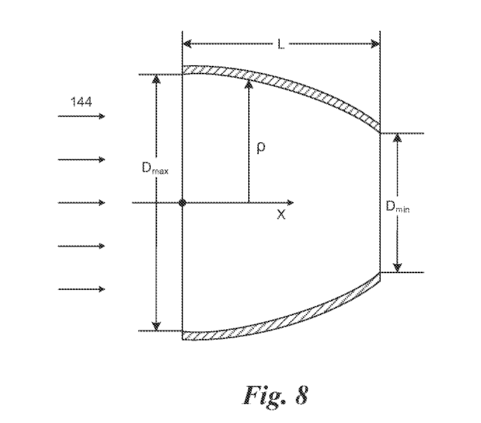

FIG. 8 is a cross-sectional view of the flow conditioner 124 of FIGS. 4 and 5 configured in accordance with an embodiment of the present technology. The illustrated flow conditioner 124 is a converging flow conditioner. In operation, air flow 144 enters the flow conditioner 124 at its inlet (with larger diameter Dₘₐₓ) and proceeds along an airflow path toward an outlet (with downstream diameter Dₘᵢₙ). The flow 144 accelerates as the pressure decreases along a centerline of the flow conditioner 124. In some embodiments, the turbine rotor (not shown) can be positioned proximate the outlet of the flow conditioner 124. The flow conditioner 124 comprises a radius ρ and a depth L. The radius ρ at a position x along a center axis can be selected, for example, using Equation 3 below to help minimize pressure losses and to improve efficiency of the flow conditioner 124.

$$ρ = \frac{{D}_{max}}{{D}_{min}} - 3.2 ( {D}_{max} - {D}_{min} ) {( \frac{x}{L} )}^{2} + ( {D}_{max} - {D}_{min} ) \frac{{x}^{3}}{L} \qquad ( 3 )$$

In the illustrated embodiment, the radius ρ decreases non-linearly from the left to the right, i.e., from an air flow inlet of the flow conditioner 124 to the air flow outlet. In other embodiments, however, the radius ρ may be selected using different parameters.

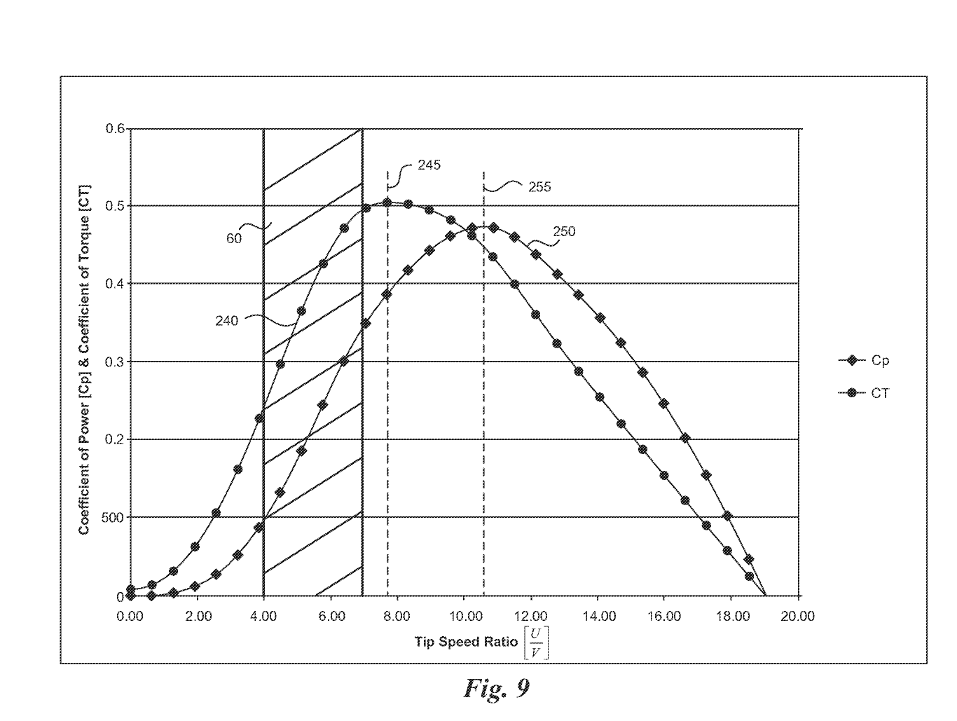

FIG. 9 is a graph illustrating coefficient of power and coefficient of torque as a function of tip speed ratio for a turbine configured in accordance with the present technology. In the graph, tip speed ratio is on the horizontal axis and a coefficient of power (Cₚ) and coefficient of torque (C_{T}) are on the vertical axis. The tip speed ratio represents a ratio of the speed of the tip of the turbine blade versus the incoming air velocity. The tip speed ratio range on the horizontal axis of the graph ranges from zero (meaning that the turbine does not rotate) to about 19 (meaning that the speed of the turbine blade tip is about 19 times greater than the velocity of the incoming exhaust air). Without wishing to be bound by theory, the coefficient of power can be understood as a ratio of energy extracted from the incoming air flow and the total available kinetic energy in the incoming air flow, per unit time. Similarly, the coefficient of torque can be understood as a ratio of the torque measured at the turbine shaft versus the highest torque theoretically extractable from the incoming flow of air. In one particular embodiment of the present technology, a line 255 indicates that a maximum coefficient of power for the turbine is about 47% and is achieved at the tip speed ratio of about 10.5. A line 245 indicates a maximum coefficient of torque for this embodiment at about 50% and is achieved at the tip speed ratio of about 7.5. In contrast to the peak efficiency tip speed ratios achieved by a turbine configured in accordance with the present technology, a typical conventional turbine operates within a region 60. The tip speed ratios are lower in the region 60, approximately 5 to 7, resulting in a correspondingly lower speed of the blade tip for peak coefficient of power and coefficient of torque for such conventional turbines.

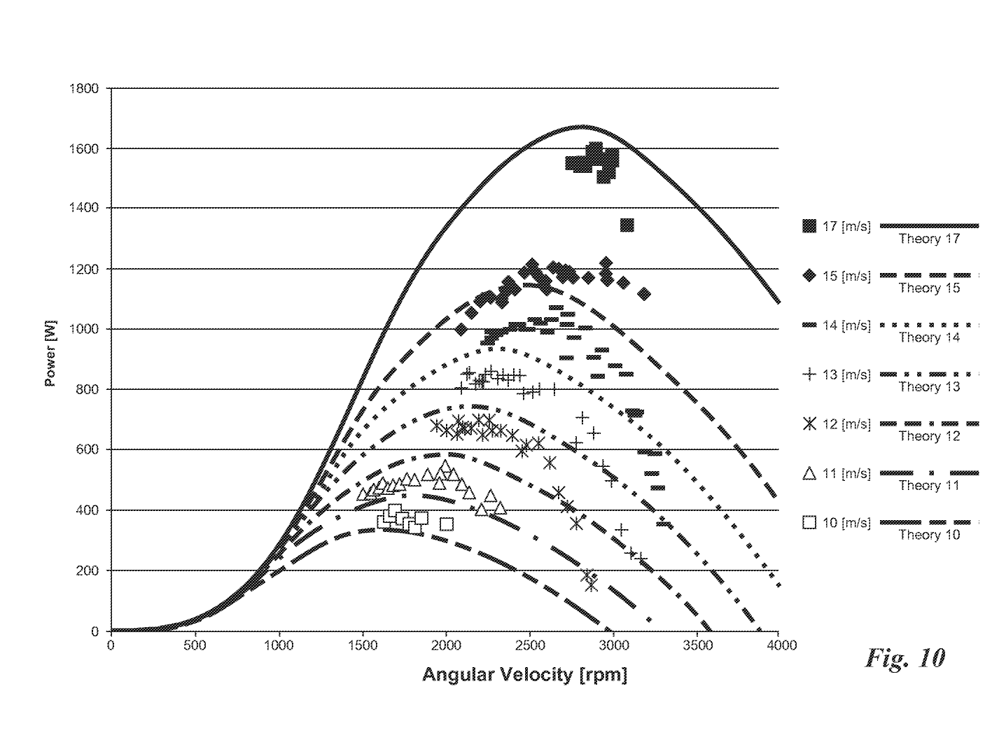

FIG. 10 is a graph illustrating theoretical and measured power as a function of angular velocity for a turbine configured in accordance with the present technology. In the graph, angular velocity (RPM) is on the horizontal axis and power (W) is on the vertical axis. The graph, for example, includes theoretical and measured results at several speeds of the incoming flow of exhaust air, ranging from about 10 m/s to about 17 m/s. In one particular embodiment, the power extracted from the flow of the exhaust air increases with the velocity of the exhaust air, reaching about 1,600 watt for the highest measured exhaust air velocity of about 17 m/s. For a fixed value of the velocity of the incoming exhaust air, power generated by the turbine changes with its angular velocity. For most of the measured velocities of the incoming exhaust air, the maximum power extraction occurs between 1,500 and 3,500 RPM, which is an angular velocity suitable for a direct connection of the turbine shaft and the generator without a need for an intervening gearbox. The measured power (shown by the symbols) generally corresponds well with the theoretical values of turbine power (shown by lines) for a given velocity of the exhaust air. For a lower range of the exhaust air velocities (e.g., ranging from about 10 m/s to about 14 m/s) the measured values of power tend to be higher than their corresponding theoretical values at or proximate to peak power for a given velocity of the exhaust air flow. For the highest velocity of the incoming exhaust air flow (17 m/s) the measured values of power tend to be somewhat lower than their theoretical counterparts at or around peak power.

### B. EXAMPLES

1. An energy recovery apparatus for extracting energy from a ventilation exhaust, the energy recovery apparatus comprising:
a turbine rotor having a plurality of turbine blades, wherein the turbine blades are at least partially airfoils;
a flow conditioner positioned to direct exhaust flow to the turbine; and
a. rotating shaft connecting the turbine with an electrical generator,
wherein the flow conditioner is offset in a streamwise direction from an outlet of the exhaust flow.

2. The energy recovery apparatus of example 1 wherein the turbine blades are at least partially NACA airfoils.

3. The energy recovery apparatus of example 2 wherein the NACA airfoil is an NACA 4415 airfoil.

4. The energy recovery apparatus of example 1 wherein the turbine blades are at least partially SG60XX airfoils.

5. The energy recovery apparatus of example 4 wherein the SG60XX airfoil is an SG6043 airfoil.

6. The energy recovery apparatus of example 1 wherein the turbine rotor has two turbine blades.

7. The energy recovery apparatus of example 1 wherein the turbine rotor has a coefficient of power greater than 40%.

8. The energy recovery apparatus of example 1 wherein the turbine blades have a fixed pitch.

9. The energy recovery apparatus of example 1 wherein the turbine blades have a twist angle (θ) generally following an unequality:

$$10 - 71.18 \frac{r}{R} + 185.1 {( \frac{r}{R} )}^{2} - 177.4 {( \frac{r}{R} )}^{3} < θ < 60.24 - 142.1 \frac{r}{R} + 86.37 {( \frac{r}{R} )}^{2} - 5.925 {( \frac{r}{R} )}^{3}$$

where R is a total span of the turbine blade and r is a location along the total span.

10. The energy recovery apparatus of example 1 wherein the turbine blades have a chord (c) generally following an unequality:

$$8.5 - 28.14 \frac{r}{R} + 62.85 {( \frac{r}{R} )}^{2} - 57.14 {( \frac{r}{R} )}^{3} < c / R < 62.70 - 205.2 \frac{r}{R} + 241.8 {( \frac{r}{R} )}^{2} - 96.29 {( \frac{r}{R} )}^{3}$$

where R is a total span of the turbine blade and r is a location along the total span.

11. The energy recovery apparatus of example 1 wherein:
the turbine rotor includes a turbine inset having a turbine inset face and a generally conical turbine inset side; and
the rotating shaft includes a shaft face positioned to face the turbine inset face and a generally conical shaft side.

12. The energy recovery apparatus of example 1 wherein the flow conditioner has a streamwise outline generally following a polynomial equation:

$$ρ = \frac{{D}_{max}}{{D}_{min}} - 3.2 ( {D}_{max} - {D}_{min} ) {( \frac{x}{L} )}^{2} + ( {D}_{max} - {D}_{min} ) \frac{{x}^{3}}{L}$$

where ρ is a radius of the flow conditioner at a position x along a center axis, Dₘₐₓ is an inlet diameter of the flow conditioner, Dₘᵢₙ is an outlet diameter of the flow conditioner, and L is a depth of the flow conditioner.

13. The energy recovery apparatus of example 1 wherein the flow conditioner is offset in the stream:vise direction from the outlet of the exhaust flow by a distance corresponding to 25% to 200% of an inlet diameter of the flow conditioner.

14. The energy recovery apparatus of example 1 wherein the turbine rotor and a rotor of the electrical generator are configured to rotate with the same angular velocity.

15. The energy recovery apparatus of example 1, further comprising a voltage converter, wherein a voltage output from the voltage converter corresponds to a voltage at a wiring cabinet configured to provide energy to a ventilation fan.

16. An energy recovery apparatus for extracting energy from ventilation exhausts, the energy recovery apparatus comprising:
a turbine having two or more turbine blades at least artially corresponding to airfoils;
a flow conditioner positioned to direct exhaust flow to the turbine;
a rotating shaft connecting the turbine with an electrical generator; and
a voltage converter configured to convert a first voltage from the electrical generator to a second voltage suitable for providing power to a fan,
wherein the flow conditioner is offset in a streamwise direction from outlet of the exhaust flow.

17. The energy recovery apparatus of example 16 wherein the rotating shaft is configured to rotate within a range of approximately 1500-3500 RPM.

18. The energy recovery apparatus of example 16 wherein the second voltage is a 3-phase, 480V voltage.

19. The energy recovery apparatus of example 16 wherein the turbine blades are forward swept.

20. A method for recovering waste energy from an air exhaust, the method comprising:
providing a flow of air from the air exhaust into a flow conditioner, wherein the flow conditioner is offset in a streamwise direction from an outlet of the air exhaust;
directing the air flow through the flow conditioner turbine rotor having a plurality of turbine blades;
rotating the turbine rotor, wherein the turbine rotor is attached to a rotating shaft; and
rotating an electrical generator on the rotating shaft to generate electricity.

21. The method of example 20, further comprising conditioning the electricity to a voltage suitable for a ventilation fan.

22. The method of example 20 wherein the turbine blades are at least partially NACA family airfoils.

23. The method of example 20 wherein the turbine blades are at least partially SG60XX family airfoils.

24. The method of example 20 wherein a distance from the air exhaust to the flow conditioner is selected based, at least in part, on an inlet diameter of flow conditioner.

25. The method of example 20 wherein the turbine is configured to extracts 30-50% of the kinetic energy flux from the exhaust flow.

### C. CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. Further, while steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An energy recovery apparatus for extracting energy from a ventilation exhaust, the energy recovery apparatus comprising:
a turbine rotor having a plurality of turbine blades, wherein the turbine blades are at least partially airfoils;
a flow conditioner positioned to direct exhaust flow to the turbine; and
a rotating shaft connecting the turbine with an electrical generator,
wherein the flow conditioner is offset in a streamwise direction from an outlet of the exhaust flow.

2. The energy recovery apparatus of claim 1 wherein the turbine blades are at least partially NACA airfoils.

3. The energy recovery apparatus of claim 2 wherein the NACA airfoil an NACA 4415 airfoil.

4. The energy recovery apparatus of claim 1 wherein the turbine blades are at least partially SG60XX airfoils.

5. The energy recovery apparatus of claim 4 wherein the SG60XX airfoil is an SG6043 airfoil.

6. The energy recovery apparatus of claim 1 wherein the turbine rotor has two turbine blades.

7. The energy recovery apparatus of claim 1 wherein the turbine rotor has a coefficient of power greater than 40%.

8. The energy recovery apparatus of claim 1 wherein the turbine blades have a fixed pitch.

9. The energy recovery apparatus of claim 1 wherein the turbine blades have a twist angle (θ) generally following an inequality:
$$10 - 71.18 \frac{r}{R} + 185.1 {( \frac{r}{R} )}^{2} - 177.4 {( \frac{r}{R} )}^{3} < θ < 60.24 - 142.1 \frac{r}{R} + 86.37 {( \frac{r}{R} )}^{2} - 5.925 {( \frac{r}{R} )}^{3}$$
where R is a total span of the turbine blade and r is a location along the total span.

10. The energy recovery apparatus of claim i wherein the turbine blades have a chord (c) generally following an unequality:
$$8.5 - 28.14 \frac{r}{R} + 62.85 {( \frac{r}{R} )}^{2} - 57.14 {( \frac{r}{R} )}^{3} < c / R < 62.70 - 205.2 \frac{r}{R} + 241.8 {( \frac{r}{R} )}^{2} - 96.29 {( \frac{r}{R} )}^{3}$$
where R is a total span of the turbine blade and r is a location along the total span.

11. The energy recovery apparatus of claim 1 wherein:
the turbine rotor includes a turbine inset having a turbine inset thee and a generally conical turbine inset side; and
the rotating shaft includes a shaft face positioned to face the turbine inset face and a generally conical shaft side.

12. The energy recovery apparatus of claim 1 wherein the flow conditioner has a streamwise outline generally following a polynomial equation:
$$ρ = \frac{{D}_{max}}{{D}_{min}} - 3.2 ( {D}_{max} - {D}_{min} ) {( \frac{x}{L} )}^{2} + ( {D}_{max} - {D}_{min} ) \frac{{x}^{3}}{L}$$
where ρ is a radius of the flow conditioner at a position x along a center axis, Dₘₐₓ is an inlet diameter of the flow conditioner, Dₘᵢₙ is an outlet diameter of the flow conditioner, and L is a depth of the flow conditioner.

13. The energy recovery apparatus of claim 1 wherein the flow conditioner is offset in the streamwise direction from the outlet of the exhaust flow by a distance corresponding to 25% to 200% of an inlet diameter of the flow conditioner.

14. The energy recovery apparatus of claim 1 wherein the turbine rotor and a rotor of the electrical generator are configured to rotate with he same angular velocity.

15. The energy recovery apparatus of claim 1, further comprising a voltage converter, wherein a voltage output from the voltage converter corresponds to a voltage at a wiring cabinet configured to provide energy to a ventilation fan.

16. An energy recovery apparatus for extracting energy from ventilation exhausts, energy recovery apparatus comprising:
a turbine having two or more turbine blades at least partially corresponding to airfoils;
a flow conditioner positioned to direct exhaust flow to the turbine;
a rotating shaft connecting the turbine with an electrical generator; and
a voltage converter configured to convert a first voltage from the electrical generator to a second voltage suitable for providing power to a fan,
wherein the flow conditioner is offset in a streamwise direction from an outlet of the exhaust flow.

17. The energy recovery apparatus of claim 16 wherein the rotating shaft is configured to rotate within a range of approximately 1500-3500 RPM.

18. The energy recovery apparatus of claim 16 wherein the second voltage is a 3-phase, 480V voltage.

19. The energy recovery apparatus of claim 16 wherein the turbine blades are forward swept.

20. A method for recovering waste energy from an air exhaust, the method comprising:
providing a flow of air from the air exhaust into a flow conditioner, wherein the flow conditioner is offset in a streamwise direction from an outlet of the air exhaust;
directing the air flow through the flow conditioner to a turbine rotor having a plurality of turbine blades;
rotating the turbine rotor, wherein the turbine rotor is attached to a rotating shaft; and
rotating an electrical generator on the rotating shaft to generate electricity.

21. The method of claim 20, further comprising conditioning the electricity to a voltage suitable for a ventilation fan.

22. The method of claim 20 wherein the turbine blades are at least partially NACA family airfoils.

23. The method of claim 20 wherein the turbine blades are at least partially SG60XX family airfoils.

24. The method of claim 20 wherein a distance from the air exhaust to the flow conditioner is selected based, at least in part, on an inlet diameter of flow conditioner.

25. The method of claim 20 wherein the turbine is configured to extracts 30-50% of the kinetic energy flux from the exhaust flow.
